(19) United States
(12) Patent Application Publication
(10) Pub. No.: US 2026/0337317 A1
(43) Pub. Date: Oct. 29, 2026

(54) PERFLUOROELASTOMER COMPOUNDS

(71) Applicant: DUPONT SPECIALTY PRODUCTS OPERATIONS SARL, Meyrin (CH)

(72) Inventors: Jean-Luc MATOUX, Meyrin (CH); Alain KIM, Meyrin (CH)

(21) Appl. No.: 19/108,535

(22) PCT Filed: Nov. 20, 2023
(86) PCT No.: PCT/EP2023/082364

§ 371 Date: Mar. 4, 2025

Related U.S. Application Data
(60) Provisional application No. 63/384,695, filed on Nov. 22, 2022.

(51) Int. Cl. C08F 214/26; C08F 216/14; C08K 3/04

(52) U.S. Cl. CPC C08F 214/262; C08F 216/1408; C08K 3/04; C08K 2201/006

(57) ABSTRACT

This invention relates to perfluoroelastomer compounds containing specific types of carbon black, and cured articles formed from the compounds. The compounds show good processability during its manufacturing process, as well as many useful properties for cured perfluoroelastomer articles.

### CROSS-REFERENCE TO RELATED APPLICATION

This application claims the benefit of U.S. Provisional Application No. 63/384,695, filed on Nov. 22, 2022, the disclosure of which is hereby expressly incorporated herein by reference in its entirety.

### TECHNICAL FIELD

This invention relates to perfluoroelastomer compounds comprising specific types of carbon black, and cured articles formed from the compounds.

### BACKGROUND

Perfluoroelastomer articles have achieved outstanding commercial success because they can be used in severe environments, in particular, during exposure to high temperatures and to aggressive chemicals. For example, these articles are used in seals in hot or otherwise sections of aircraft engines, in oil-well drilling devices, and as sealing elements in industrial equipment that operate at high temperatures.

The properties of perfluoroelastomer articles arise largely because of the stability and inertness of the copolymerized monomers that make up the major portion of the polymeric backbone of these compounds. Such monomers include tetrafluoroethylene and perfluoro (alkyl vinyl) ethers. In order to develop elastomeric properties fully, elastomer compounds are typically crosslinked, i.e., vulcanized or cured. To this end, a small percentage of cure site monomer is copolymerized with the monomers. Upon crosslinking, the cure site monomer reacts with a curing agent to form a crosslinked elastomer entity in the form of an article.

Mechanical properties such as low compression set are also required of perfluoroelastomer articles for use of the article in various industries. Mechanical properties of cured elastomer compounds are normally adjusted by incorporating additives. Carbon black is used as an additive to improve mechanical properties. U.S. Pa. No. 10,472,494, which is hereby incorporated herein by reference in its entirety, discloses fluoroelastomer compounds containing specific types of curing agent and carbon black with average particle sizes at least about 100 nm to about 500 nm.

During the cure of the perfluoroelastomer compositions, torque of the compositions is increased as the crosslink is increased. As torque is increased, the composition gets very difficult to be processed. Therefore, there is a need for improved processability during the cure process.

### BRIEF SUMMARY

Perfluoroelastomer compounds comprising specific types of carbon black show good processability during the manufacturing process, as well as many useful properties for cured perfluoroelastomer articles.

The invention is directed to a compound comprising: a perfluoroelastomer comprising at least the following two copolymerized monomer units,
(1) one or more perfluorinated olefins; and
(2) a perfluorovinyl ether selected from the group consisting of perfluoro (alkyl vinyl) ethers, perfluoro (alkoxy vinyl) ethers, and a mixture of perfluoro (alkyl vinyl) ethers and perfluoro (alkoxy vinyl) ethers; and
(3) at least one cure site selected from the composition comprising a group or an atom selected from bromine atoms, iodine atoms and nitrile group,
(B) one or more curing agent, and
(C) one or more carbon black, at least one of the carbon black has between 20 and 40 m²/g of STSA.

The invention is further directed to an article produced using the compound disclosed above.

### BRIEF DESCRIPTION OF DRAWINGS

FIG. 1 is Moving Die Rheometer (MDR) curves that show cure rate, especially for Ts2 and T90, for compounds comprising the specific carbon black or conventional carbon black respectively.

FIG. 2 is MDR curves that show cure rate, especially for Ts2 and T90, for compounds comprising a half amount of coagent with the specific carbon black or conventional carbon black, respectively.

### DETAILED DESCRIPTION

### Abbreviations

The claims and description herein are to be interpreted using the abbreviations and definitions set forth below.
“h”, “hrs” refers to hours.
“%” refers to the term percent.
“mole %” refers to mole percent.
“wt %” refers to weight percent.
“°C” refers to degree Celsius.
“parts” refers to parts by weight.
“phr” refers to parts per hundred parts of perfluoroelastomer (rubber); one of skill in the art uses and recognizes this term of measurement. For example, 3 parts of a component per 100 parts perfluoroelastomer is written as 3 phr. In these compounds, processes, and articles described herein, phr is based on 100 parts of perfluoroelastomer.
“g” refers to grams.
“Ph” refers to a phenyl ring.

### DEFINITIONS

As used herein, the article “a” refers to one as well as more than one and does not necessarily limit its referent noun to the grammatical category of singular number.

As used herein, the terms “about” and “at or about”, when used to modify an amount or value, refers to an approximation of an amount or value that is more or less than the precise amount or value recited in the claims or described herein. The precise value of the approximation is determined by what one of skill in the art would recognize as an appropriate approximation to the precise value. As used herein, the term conveys that similar values, not precisely recited in the claims or described herein, can bring about results or effects that are equivalent to those recited in the claims or described herein, for which one of skill in the art would acknowledge as acceptably brought about by the similar values.

As used herein, the term “article” refers to an unfinished or finished item, thing, object, or an element or feature of an unfinished or finished item, thing or object. As used herein, when an article is unfinished, the term “article” may refer to any item, thing, object, element, device, etc. that has a form, shape, configuration that may undergo further processing in order to become a finished article. When an article is unfinished, the term “preform” may refer to that form, shape, configuration, any part of which may undergo further processing to become finished. As used herein, when an article is finished, the term “article” refers to an item, thing, object, element, device, etc. that is in a form, shape, configuration that is suitable for a particular use/purpose without further processing of the entire entity or a portion of it.

An article may comprise one or more element(s) or subassembly(ies) that either are partially finished and awaiting further processing or assembly with other elements/subassemblies that together will comprise a finished article. In addition, as used herein, the term “article” may refer to a system or configuration of articles.

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present). As used herein, the terms “comprises,” “comprising,” “includes,” “including,” “has,” “having”, “consisting essentially of”, and “consisting of” or any other variation of these, may refer either to a non-exclusive inclusion or to an exclusive inclusion.

When these terms refer to a more exclusive inclusion, these terms limit the scope of a claim to those recited materials or steps that materially affect the novel elements of the recited invention.

When these terms refer to a wholly exclusive inclusion, these terms exclude any element, step or component not expressly recited in the claim. As used herein, terms that describe molecules or polymers follow the terminology in the IUPAC Compendium of Chemical Terminology_version 2.15 (International Union of Pure and Applied Chemistry) of Sep. 7, 2009.

As used herein, the prefix term “perfluoro”, when placed as a prefix before a chemical entity name, refers to every hydrogen atom of the chemical entity has been replaced by fluorine atom.

As used herein, the term “perfluorinated olefin” refers to linear, branched, or cyclic perfluorinated hydrocarbon structures which comprise at least one unsaturated double bond.

As used herein, the term “alkyl” refers to linear, branched, or cyclic hydrocarbon structures and combinations of there. Alkyl does not include aromatic structures. Examples of linear alkyl groups include methyl, ethyl, propyl, butyl, pentyl, and hexyl groups. Branched alkyl groups include for example s- and t-butyl, and isopropyl groups. Examples of cyclic hydrocarbon groups include cyclopropyl, cyclopentyl, cyclohexyl, cyclobutyl, and cyclooctyl groups.

As used herein, the term “alkoxy” or “alkoxyl” refers to alkyl groups attached to an oxygen atom by a single bond. The other bond of the oxygen atom is connected to a carbon atom. Examples include methoxy, ethoxy, propoxy, isopropoxy, cyclopropyloxy, and cyclohexyloxy.

As used herein, the term “another curing agent different from curing agent B” refers to a curing agent that does not have the same chemical structure as curing agent B.

As used herein, the term “compound” refers to a composition that is able to be cured, i.e., a curable composition, as well as to a mixture of chemical entities that comprises at least a perfluoroelastomer and a curing agent. The mixture of chemical entities has not been cured nor has undergone processing conditions that would cause the curing of the mixture of chemical entities to undergo curing.

As used herein, the term “cured” refers to that resultant entity that comprised a perfluoroelastomer and which has been exposed to those conditions that caused the perfluoroelastomer molecules to form sufficient crosslinks among themselves (that is, curing conditions) such that the resultant entity takes on a form or shape or configuration or structure that cannot be reprocessed, molded, or extruded into a different one. That is, once a resultant entity which comprised a perfluoroelastomer has been exposed to curing conditions to thereby be cured, that entity cannot be re-cured to take on a substantially different form or shape or configuration or structure.

As used herein, the terms “curing”, “cured” refer to that processing of a compound, also called herein curable composition, which results in an entity taking on a form or shape or configuration or structure that cannot be reprocessed, molded, or extruded into a different one. Such processing refers to the “curing process/processing”, which requires compounds to be exposed to certain conditions in order to initiate the curing process, such conditions called curing conditions.

The resultant entity of the curing process is a “cured” entity, that is, an article as defined hereinabove. To be clear, curing results in compounds taking on a form or shape or configuration or structure of an article. Cured articles of compounds described herein include, but are not limited to, O-rings, seals, and gaskets.

The terms “curing”, “cured” also expressly include differing degrees of processing of a compound such that the resultant entity takes on a form or shape or configuration or structure that cannot be reprocessed, molded, or extruded into a different one and which may exhibit certain physical properties as a result of the curing.

To the point, these compounds may be initially cured to achieve a non-reprocessable form, shape, etc., which has been termed “cured” herein. The cured compounds may be further subjected to additional curing conditions, which provide additional, subsequent curing. Such additional curing conditions may be variously termed herein either as “curing” or as “post-curing”. That is, the terms “curing”, “cured” refer to both an initial curing process that results in a first cured, resultant entity and also expressly refer to any subsequent curing process that results in a subsequently cured, resultant entity that may or not possess different material or physical properties than those of the first cured, resultant entity.

### Ranges and Preferred Variants

Any range set forth herein expressly includes its endpoints unless explicitly stated otherwise. Setting forth an amount, concentration, or other value or parameter as a range specifically discloses all possible ranges formed from any possible upper range limit and any possible lower range limit, regardless of whether such pairs of upper and lower range limits are expressly disclosed herein. Compounds, processes and articles described herein are not limited to specific values disclosed in defining a range in the description.

The disclosure herein of any variation in terms of materials, chemical entities, methods, steps, values, and/or ranges, etc.-whether identified as preferred or not—of the processes, compounds and articles described herein specifically intends to include any possible combination of materials, methods, steps, values, ranges, etc. For the purpose of providing photographic and sufficient support for the claims, any disclosed combination is a preferred variant of the processes, compounds, and articles described herein.

### Compounds

### A) Perfluoroelastomers

Perfluoroelastomers described herein comprise at least the following two copolymerized monomer units: (1) one or more perfluorinated olefins and (2) a perfluorovinyl ether monomer selected from the group consisting of perfluoro (alkyl vinyl) ethers, perfluoro (alkoxy vinyl) ethers, or a mixture of perfluoro (alkyl vinyl) ethers and perfluoro (alkoxy vinyl) ethers, and (3) at least one cure site selected from the group consisting of bromine atoms, iodine atoms and nitrile group.

Alternatively, the perfluoroelastomers described herein comprise at least the following two copolymerized monomer units: (1) about 25 to about 74.9 mole percent of one or more perfluorinated olefins and (2) about 10 to about 74.9 mole percent perfluorovinyl ether monomers selected from the group consisting of perfluoro (alkyl vinyl) ethers, perfluoro (alkoxy vinyl) ethers, or a mixture of perfluoro (alkyl vinyl) ethers and perfluoro (alkoxy vinyl) ethers, and (3) about 0.1 to 3 mole percent of a cure site selected from the group consisting of bromine atoms, iodine atoms and nitrile group, wherein the mole percent of each of (1), (2), and (3) is based on the total mole percent of (1), (2), and (3) in perfluoroelastomer.

Perfluoroelastomers described herein may contain any of a variety of end groups as a result of the use of varying initiators or chain transfer agents during polymerization. Non-limiting examples of end groups include sulfonate, sulfonic acid, carboxylate, carboxylic acid, carboxamide, difluoromethyl groups, trifluorovinyl groups, or perfluorinated alkyl groups

### (1) Copolymerized Perfluorinated Olefin

Copolymerized perfluorinated olefins includes perfluorinated olefins. Examples of perfluorinated olefins include tetrafluoroethylene (C₂F₄), hexafluoropropylene, and a mixture of tetrafluoroethylene and hexafluoropropylene. The concentration of perfluorinated olefin is about 25 and 74.9 mole percent of the total moles of monomer units in perfluoroelastomer.

### (2) Perfluorovinyl Ether Monomer

Perfluorovinyl ether monomer includes, perfluoro (alkyl vinyl) ethers (PAVE), perfluoro (alkoxy vinyl) ethers, and mixtures of these.

Suitable perfluorovinyl ether monomers include those having any one of formula (I), (II), (III), (IV) or (V) hereinbelow.

CF₂═CFO(R_{f′}O)n(R_{f″})ₘR_{f} (I)
where R_{f′} and R_{f″} are linear or branched perfluoroalkylene groups of 2-6 carbon atoms, m and n are independently 0-10, and R_{f} is a perfluoroalkyl group of 1-6 carbon atoms.

CF₂—CFO(CF₂CFXO)ₙR_{f} (II),
where X is F or CF₃, n is 0-5, and R_{f} is a perfluoroalkyl group of 1-6 carbon atoms. Preferably, n is 0 or 1 and R_{f} contains 1-3 carbon atoms. Examples of such perfluorovinyl ether monomers include perfluoro(methyl vinyl) ether and perfluoro (propyl vinyl) ether.

CF₂═CFO[(CF₂)ₘCF₂CFZO]ₙR_{f} (III),
where R_{f} is a perfluoroalkyl group having 1-6 carbon atoms, m=0 or 1, n=0-5, and Z═F or CF₃.

CF₂═CFO[(CF₂CFCF₃O)ₙ(CF₂CF₂CF₂O)ₘ(CF₂)ₚ]CₓF₂ₓ₊₁ (IV),
where m and n=1-10, p=0-3, and x=1-5 and includes monomers where n=m=0-1, and x=1.

CF₂═CFOCF₂CF(CF₃)O(CF₂O)ₘCₙF₂ₙ₊₁ (V),
where n=1-5, m=1-3, and where, alternatively, n=1.

Mixtures of perfluoro (alkyl vinyl) ethers and perfluoro (alkoxy vinyl) ethers may also be used.

The concentration of perfluorovinyl ether monomers ranges from about 10 to 74.9 mole percent, alternatively from 15 to 60 mole percent, of the total mole percent of (1) Copolymerized Perfluorinated Olefin, (2) Perfluorovinyl Ether Monomer and (3) Cure Site Monomer in perfluoroelastomer.

### A (3) Cure Site

Perfluoroelastomer further comprises one or more cure site. Suitable cure site includes fluorinated olefins that include nitrile-containing or which comprise one or more bromine atoms or one or more iodine atoms or mixtures of these.

Such fluorinated olefins include cure site having formula (VI) or (VII):

CR²R²═(CR³R⁴)n-CR⁵R⁶ (VI)
where n=1-4; R¹, R², R³, R⁴, and R⁵═H or F wherein at least one of R¹ to R⁵ is F; and R⁶ is Br or I, preferably I; or

CF₂═CF—O(CR⁷R⁸)ₙ—R⁹ (VII)
where n=1-4; R⁷ and R⁸═H or F wherein at least one of R⁷ or R⁸ is F; and R⁹ is Br or I, alternatively I.

A perfluoroelastomer comprising a cure site can also be obtained by a polymerization method carried out using a bromine compound or an iodine compound as the chain transfer agent.

Typical examples of the bromine compound or iodine compound used include compounds represented by the formula (VIII):

R¹⁰IₓBr_{y} (VIII)
wherein x and y are each an integer of 0 to 2 and satisfy 1≤x+y≤2; and R¹⁰ is a saturated or unsaturated fluorohydrocarbon group or chlorofluorocarbon group having 1 to 16 carbon atoms, or is a hydrocarbon group having 1 to 3 carbon atoms that optionally includes an oxygen atom. By using a bromine compound or an iodine compound, the iodine or bromine is introduced into the polymer and may function as a crosslinking point.

Examples of the bromine compound or iodine compound include i,3-diiodoperfluoropropane, 2-iodoperfluoropropane, 1,3-diiodo-2-chloroperfluoropropane, 1,4-diiodoperfluorobutane, i,5-diiodo-2,4-dichloroperfluoropentane, 1,6-diiodoperfluorohexane, 1,8-diiodoperfluorooctane, i,12-diiodoperfluorododecane, 1,16-diiodoperfluorohexadecane, diiodomethane, 1,2-diiodoethane, i,3-diiodo-n-propane, CF₂Br₂, BrCF₂CF₂Br, CF₃CFBrCF₂Br, CFClBr₂, BrCF₂CFClBr, CFBrClCFClBr, BrCF₂CF₂CF₂Br, BrCF₂CFBrOCF₃, i-bromo-2-iodoperfluoroethane, 1-bromo-3-iodoperfluoropropane, i-bromo-4-iodoperfluorobutane, 2-bromo-3-iodoperfluorobutane, 3-bromo-4-iodoperfluorobutene-1,2-bromo-4-iodoperfluorobutene-i, and monoiodomonobromo-substituted products, diiodomonobromo-substituted products, and (2-iodoethyl)- and (2-bromoethyl)-substituted products of benzene. These compounds may be used singly or may be used in combination with each other. Among these, from the viewpoint of polymerization reactivity, crosslinking reactivity, and availability, it is preferable to use 1,4-diiodoperfluorobutane, 1,6-diiodoperfluorohexane, and 2-iodoperfluoropropane.

Suitable cure site may also include nitrile-containing fluorinated olefins and nitrile-containing fluorinated vinyl ethers. Useful nitrile-containing cure site monomers include compounds of formulae (IX)-(XIII):

CF₂—CF—O(CF₂)ₙ—CN (IX),
where n=2-12, preferably 2-6;

CF₂═CF—O[CF₂—CFCF₃—O]ₙ—CFCF₃—CN (X),
where n=0-4, preferably 0-2;

CF₂═CF—[OCF₂CFCF₃])ₓ—O—(CF₂)ₙ—CN (XI),
where x=1-2, and n=1-4;
   and

CF₂═CF—O—(CF₂)ₙ—O—CF(CF₃)CN (XII),
where n=2-4.

Alternatively, cure site is perfluoro (8-cyano-5-methyl-3,6-dioxa-1-octene) (8-CNVE) and represented by formula (XIII):

CF₂═CFOCF₂CF(CF₃)OCF₂CF₂CN (XIII)

Perfluoroelastomer may comprise any of a variety of end groups as a result of the use of varying initiators or chain transfer agents during polymerization. Non-limiting examples of end groups include sulfonate, sulfonic acid, carboxylate, carboxylic acid, carboxamide, difluoromethyl groups, trifluorovinyl groups, or perfluorinated alkyl groups.

Cure site in the compounds described herein range from about 0.1 to about 10 mole percent, alternatively from 0.3 to 7 mole percent, and alternatively from 0.3 to 2 mole percent of the total moles of polymerizable monomer units in perfluoroelastomer.

### (B) Curing Agent

The perfluoroelastomers employed in the compounds of the present invention are capable of undergoing crosslinking reactions with any of the known curatives for perfluoroelastomers such as, but not limited to, polyhydroxy compounds such as the combination of organic peroxides and polyfunctional coagents (U.S. Pat. Nos. 4,214,060; 4,983,680), organotin (U.S. Pat. No. 5,789,489), bis(aminophenols) such as diaminobisphenyl AF (U.S. Pat. No. 6,211,319 B1), aromatic tetraamines such as 3,3′-diaminobenzidine, 2,2-bis[3-amino-4-(N-phenylamino)phenyl]hexafluoropropane, and ammonia generating compounds such as urea and other compounds disclosed in U.S. Pat. No. 6,281,296 and WO 01/27194.

One curing agent that may be employed is an organic peroxide/polyfunctional coagent system. Useful organic peroxides are those which generate free radicals at curing temperatures. A dialkyl peroxide or a bis(dialkyl peroxide) which decomposes at a temperature above 50 °C is especially preferred. In many cases it is preferred to use a ditertiarybutyl peroxide having a tertiary carbon atom attached to a peroxy oxygen. Among the most useful peroxides of this type are 2,5-dimethyl-2,5-di(tertiarybutylperoxy)hexyne-3 and 2,5-dimethyl-2,5-di(tertiarybutylperoxy)-hexane. Other peroxides can be selected from such compounds as dicumyl peroxide, dibenzoyl peroxide, tertiarybutyl perbenzoate, and di[1,3-dimethyl-3-(t-butylperoxy)butyl]carbonate. When present in the curable compositions of the invention, 1-5 phr peroxide is typically used.

The polyfunctional coagent employed with an organic peroxide is a polyunsaturated compound that is capable of cooperating with the peroxide to provide a useful cure. These coagents can be added in an amount equal to 0.1 and 10 phr, preferably between 2-5 phr. The coagent may be one or more of the following compounds: triallyl cyanurate; triallyl isocyanurate; poly triallyl isocyanurate, tri(methallyl) isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane; and tri (5-norbornene-2-methylene) cyanurate. Particularly useful is triallyl isocyanurate (TAIC).

Other curatives which may be employed in the compounds of the invention include bis(aminophenols) such as diaminobisphenyl AF, tetraamines, organotin and compounds which decompose to produce ammonia at curing temperatures, e.g. urea. When present in the compounds of this invention, typically 0.1 to 7 phr of any one of the latter curatives is employed.

### (C) Carbon Black

The compounds of the invention comprise one or more carbon blacks.

The carbon blacks of the invention have a STSA between 20 and 40 m²/g, and alternatively, between 25 and 35 m²/g. STSA is the external surface area which is accessible to rubber, while the total surface measurement (NSA measurement) is the total surface area which includes micropores. STSA can be measured according to ASTM D6556-07.

In addition, the iodine adsorption is above 60 g/kg and ideally at least 145 g/kg. Iodide absorption can be measured according to ASTM D1510.

Furthermore, the carbon blacks of the invention preferably have a DBP Absorption at least 50 cm³/100 g, and alternatively, at least 74 cm³/100 g of nitrogen surface area. Nitrogen surface area can be measured according to ASTM D2414B. Furthermore, the pH of the carbon blacks is at least 7, and alternatively, at least 9. pH can be measured according to ASTM D1512.

This type of carbon blacks has non-detectable PAH (Poly Aromatic Hydrocarbons), with a detection limit of 5 ppb.

The carbon blacks of the invention can be amorphous.

When using such specific carbon blacks, the composition shows better processability.

Ts2 (Often described as scorch time) is used as an index of the time to show the starting time of the curing, while T90 is an index of the time that almost all of the crosslinks have been created. Such indexes are explained in ASTM D5289.

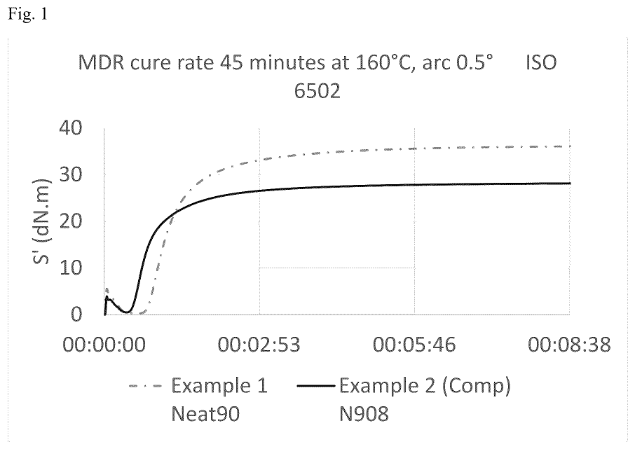

FIG. 1 is a MDR (Moving Die Rheometer) chart which shows Ts2 and T90 of two compounds. Straight line shows compound comprising conventional carbon black (Thermax N908) while dotted curve shows compound of the invention, comprising the specific carbon black (CarbonNeat 90). Ts2 of the present invention (i.e. dotted line) shifts right compared with Ts2 of the conventional one (i.e. straight line), which means Ts2 becomes longer. Longer Ts2 is preferred to get enough processing window, while shorter T90 is better to complete cured step and vet the cured article. The compounds of the invention comprising the specific carbon black, show longer Ts2 with shorter T90, i.e. better processability for molding of the composition.

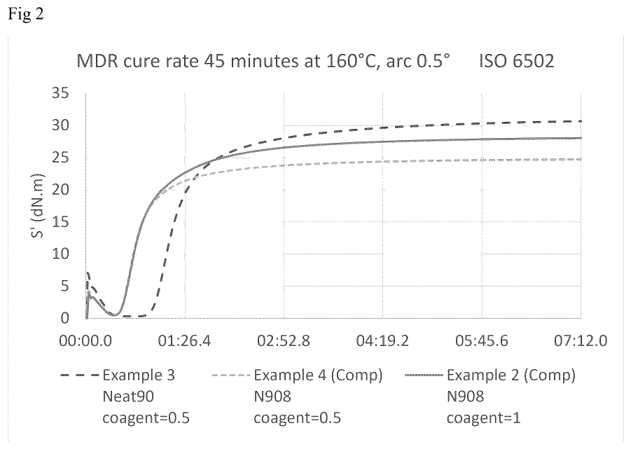

Also, as illustrated in FIG. 2, inventors of this invention found that: the amounts of coagent can be decreased when using such specific carbon black to achieve at least the same level of cross link as define by MH on a MDR and an equivalent or better. When some amounts of coagent is included in cured articles, the coagent bleeds out from the articles and leading to lower yield or not being able to produce articles.

An example of the carbon blacks which have the properties disclosed above is CarbonNeat 90 available from Cancarb Limited.

The concentration of carbon black (C) in the compounds ranges from 1 to 100 phr, alternatively, from 5 to 60 phr.

Two or more carbon blacks can be used. When two or more carbon black is used, at least one carbon black need to be the above-mentioned carbon black.

### Other Ingredients

The compounds described herein may additionally comprise a metal sulfide as disclosed in U.S. Published Patent No. 2017/0022347A. Examples of such metal sulfide include calcium sulfide, magnesium sulfide, manganese sulfide, iron sulfide, and copper sulfide. The concentration of metal sulfide is generally from about 0.1 to 20 phr, preferably from 1 to 20 phr, more preferably from 5 to 20 phr.

The compounds described herein may additionally comprise a non-perfluoro-containing elastomer capable of independently cross-linking with any perfluoroelastomer (A) cure sites. Examples of the non-perfluoro-containing elastomer are those having, at least at either its main chain or an end of its side chain, at least one kind of crosslinkable group selected from the group consisting of: cyano (—CN), carboxyl (—COOH), alkoxycarbonyl (—COOR₉, where R₉ is a monovalent organic group), and an acid halide group (—COX₁, where X₁ is a halogen atom) capable of a crosslinking reaction with perfluoroelastomer (A).

Examples of non-perfluoro-containing elastomers include, but are not limited to, a fluorine-containing, but not a perfluoro-containing, rubber; a thermoplastic fluorine-containing rubber; and a rubber composition comprising a fluorine-containing rubber.

The fluorine-containing rubber may contain a monomer unit independently selected from the group consisting of vinylidene fluoride (VDF), tetrafluoroethylene, and hexafluoropropylene, and at least one additional monomer such as tetrafluoroethylene, hexafluoropropylene, perfluoro (alkyl vinyl ether), chlorotrifluoroethylene, trifluoroethylene, trifluoropropylene, pentafluoropropylene, trifluorobutene, tetrafluoroisobutene, vinyl fluoride, and iodine-containing fluorinated vinyl ethers, ethylene, propylene, alkyl vinyl ether, and combinations of these.

Additives such as stabilizers, plasticizers, lubricants, fillers, and processing aids typically utilized in compounding can be incorporated into the compounds described herein, provided they have adequate stability for the intended service conditions. In particular, low temperature performance can be enhanced by incorporation of perfluoropolyethers.

In addition to, or in combination with carbon blacks, non-carbon black fillers may be present in the compounds described herein. An example of a non-carbon black filler that may be used includes anhydrous silica such as acidic silica or fumed silica. Such silicas are available from Degussa Aktiengesellschaft (Frankfurt, Germany) under the Aerosil® trademark. A particularly useful type is Aerosil® 200 silica. Other suitable silicas include Reolosil® silicas, available from Tokuyama KK (Tokyo, Japan), for example Reolosil® QS13, Reolosil® QS102, and Reolosil® QS30. Silica amounts range from 1 to 25 phr, but preferably no more than 1 to 7 phr.

Additional types of fillers include micropowders or fluoroadditives. Micropowders are ordinarily partially crystalline polymers. Micropowders include finely divided, easily dispersed plastic fluoropolymers that are solid at the highest temperature utilized in fabrication and curing of the compounds described herein. The term “solid” refers to a plastic fluoropolymer that has a crystalline melting temperature above the processing temperature(s) of the compounds described herein.

Micropowders that can be used in these compounds include, but are not limited to, micropowders based on the group of polymers known as tetrafluoroethylene (TFE) polymers. This group includes polytetrafluoroethylene (PTFE) and copolymers of TFE with small concentrations of about 1 mole percent or less of at least one copolymerizable modifying monomer such that the micropowders do not melt or soften during processing of perfluoroelastomer A that comprise the micropowders. The modifying monomer may be, for example, hexafluoropropylene (HFP), perfluoro(propyl vinyl) ether (PPVE), perfluorobutyl ethylene, chlorotrifluoroethylene, or another monomer that introduces side groups into the polymer molecule.

Tetrafluoroethylene polymers used as additives in these compounds include copolymers of TFE having sufficient concentrations of copolymerized units of one or more monomers to reduce the melting point below that of PTFE. Such copolymers generally have melt viscosity in the range of 0.5-60×10<3>Pa·s, but viscosities outside this range are also known. Perfluoroolefins and perfluoro (alkyl vinyl) ethers are preferred comonomers. Hexafluoropropylene and perfluoro (propyl vinyl) ether are most preferred. Examples of TFE copolymers include TFE/hexafluoropropylene copolymer and TFE/perfluoro (propyl vinyl) ether copolymers, provided they satisfy constraints on melting temperature with respect to perfluoroelastomer processing temperature. These copolymers can be utilized in powder form as isolated from the polymerization medium, if particle size is acceptable, or they can be ground to suitable particle size starting with stock of larger dimensions.

The amount of non-carbon black filler in these compounds ranges from about 0.01 to 35 phr, alternatively from 0.1 to 20 phr, alternatively at least about 1 to 5 phr.

### Process for Preparing the Compounds and Curing Articles

The compounds described herein may be prepared by mixing until homogeneous perfluoroelastomer (A), curing agent(s) (B), carbon black (C), and optional components using rubber compounding procedures such as a two-roll rubber mill, an internal mixer, or in an extruder. These compounds may be cured by the application of heat and/or of pressure sufficient to cause curing agent B to form crosslinks with cure site or a dual cure system may also be used. When compression molding is used to cure, a press cure cycle is preferably followed by a post cure cycle to achieve optimal state of cure during which the press cured compound is heated at elevated temperatures in excess of 200 °C for several hours.

When cured, the compounds described herein become articles described herein and exhibit suitable thermal stability and chemical resistance for the applications in which these articles are used. These articles are useful: as seals and gaskets for high temperature contexts, in a wide range of chemical environments, in seals for high temperature automotive uses, and O-rings.

The compounds of the present invention are useful in production of gaskets, tubing, seals and other molded components. Such articles are generally produced by molding a compounded formulation of the curable composition with various additives under pressure, curing the part, and then subjecting it to a post cure cycle. The cured compositions have excellent mechanical properties as well as excellent thermal stability and chemical resistance.

The compound of the present invention shows longer Ts2 which is preferred to get enough processing window, with shorter T90 which is preferred for shorter cure time resulting in a shorter molding cycle time of the composition. In addition, the amount of coagent bleeds out can be decreased, it contributes higher yield and avoid defect of obtained articles.

### EXAMPLES

### Cure Characteristics

Unless otherwise noted, cure characteristics were measured using a Montech D-RPA 3000 under the following conditions (ISO 6502):
Moving die frequency: 1.66 Hz
Hertz Oscillation amplitude: ±0.5°[deg.]
Temperature: 160 °C
Sample weight: 6 to 10 g
Duration: 45 minutes
The following cure parameters were recorded:
MH: maximum torque level, in units of dN·m
ML: minimum torque level, in units of dN·m
ts2: minutes to a 2.26 dNm rise above ML
tc90: minutes to 90% of maximum torque Physical Properties

### Physical Properties

Compression set were performed on plied pips according to ISO 815

### Raw Materials

Perfluoroelastomer A: a perfluoroelastomer containing (PMVE) and (TFE) were prepared by the process disclosed in U.S. Pat. No. 6,646,077 cols. 9 to 10.
Carbon black A: Neat90 (From CarbonNeat 16930 West Catawba Ave., Suite 102, Cornelius, NC 28031) STSA: 28-30
Carbon black B: N908 Ultra Pure (from Cancarb Limited) STSA: 6-9
Coagent TAIC: (TAIC DLC®-A 72% from Harwick Standard Distribution Corporation, Akron, Ohio, USA.)
Curing agent: Luperox® 101 XL 45, available from (Arkema), it is a curing agent package, including 2,5-DIMETHYL-2,5-DI-(TERT-BUTYLPEROXY) HEXANE, and mineral carriers (CaCO₃) and (SiO₂).
Coagent: TMAIC (DIAK 8 from Vanderbilt Chemicals, LLC))

### Examples 1 to 6

Compounds disclosed in Table 1 were prepared.

TABLE 1

| | | Examples | | | | | |
|---|---|---|---|---|---|---|---|
| Elements | materials | 1 | 2 (Comp) | 3 | 4(Comp) | 5 | 6(Comp) |
| Perfluoroelastomer | Perfluoroelastomer | 100 | 100 | 100 | 100 | 100 | 100 |
| | A | | | | | | |
| Carbon | A (Neat 90) | 15 | — | 15 | — | 15 | — |
| black | | | | | | | |
| Carbon | B (N908 Ultra | — | 15 | — | 15 | — | 15 |
| black | Pure) | | | | | | |
| Curing | Luperox ® 101 | 2 | 2 | 2 | 2 | 2 | 2 |
| agent | XL 45 | | | | | | |
| Coagent | DIAK 8 | — | — | — | — | 3 | 3 |
| | TAIC DLC ®- | 3 | 3 | 1.5 | 1.5 | — | — |
| | A | | | | | | |
| Properties | | | | | | | |
| Ts2 | | 0.84 | 0.56 | 1.02 | 0.55 | 2.81 | 2.71 |
| T90 | | 2.66 | 2.49 | 2.8 | 1.96 | 32.94 | 25.56 |
| Compression | | 14.6 | 26 | 17.8 | 32 | 28 | 94.1 |
| Set 25%, | | | | | | | |
| 200 degrees | | | | | | | |
| C | | | | | | | |

Curable composition (Examples 1-6) containing ingredients shown in Table 1 were made by compounding these ingredients in a conventional manner using an internal mixer and/or a two-roll rubber mill. The properties are also shown in Table 1.

Cure characteristics of these compositions and physical properties of cured test specimens (160 °C press cure for T90+5 min, followed by post cure in air oven at 232 °C for 4 hours) were measured according to the Test Methods. Results are shown in Table 1. The composition of the invention (Examples 1 and 3) shows much longer Ts2 while T90 is usually, but not limited to, equal or marginally increased.

Also, the Example 3 shows a half of coagent (1.5) is enough to get the same level of properties (compression set).

Example 5 shows that using the new carbon black described above it is possible to achieve much lower compression set when using TMAIC coagent. The reference example 6 would not be considered acceptable as a sealing element given its very high compression set.

What is claimed is:

1. A compound comprising:
(A) a perfluoroelastomer comprising at least the following two copolymerized monomer units
(1) one or more perfluorinated olefins and
(2) a perfluorovinyl ether selected from the group consisting of perfluoro (alkyl vinyl) ethers, perfluoro (alkoxy vinyl) ethers, and a mixture of perfluoro (alkyl vinyl) ethers and perfluoro (alkoxy vinyl) ethers, and
(3) at least one cure site selected from the composition comprising a group or an atom selected from bromine atoms, iodine atoms and nitrile group,
(B) one or more curing agent, and
(C) one or more carbon black, at least one of the carbon black has between 20 and 40 m²/g of STSA.

2. The compound of claim 1, wherein the curing agent (B) comprises an organic peroxide and a polyfunctional coagent.

3. The compound of claim 1, wherein the carbon black has at least 60 g/kg of iodide absorption measured according to ASTM D1510.

4. The compound of claim 1, wherein the carbon black is amorphous.

5. The compound of claim 1, wherein the carbon black comprises two or more kinds of carbon black.

6. The compound of claim 1, further comprising at least one ingredient selected from the group comprising nonperfluoro-fluorine-containing elastomers, micropowders, stabilizers, plasticizers, lubricants, processing aids, and mixtures of these.

7. An article, produced using compound any one of claims 1 to 6.

8. The article of claim 7, in the form of a molded article selected from gasket, tube, seal, diaphragm, sheets, and O-ring.
